(19) United States
(12) Patent Application Publication
(10) Pub. No.: US 2005/0230947 A1
(43) Pub. Date: Oct. 20, 2005

(54) Electronic safety device for a motor vehicle

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/991,016

(22) Filed: Nov. 17, 2004

(30) Foreign Application Priority Data
Apr. 16, 2004 (TW) 93110622

(51) Int. Cl. B60R 21/00

(52) U.S. Cl. 280/735

(57) ABSTRACT

An electronic safety device for a motor vehicle includes a mobile phone (10), a GPS module (20), an air bag assembly (40) and a trigger (30), which are all electrically connected together. The phone includes a camera module (106) adapted to take images from inside the vehicle, and a phone number stored therein. The GPS module is for providing information on a position of the vehicle. The air bag assembly includes an extensile air bag (402). When the trigger is activated, it enables the camera module to take an image, the GPS module to obtain information on the position of the vehicle and send the position information to the phone, and the extensile air bag to be instantaneously charged. The phone then sends the image and the position information to a receiver according to the phone number. Thus timely and informed help is automatically summoned for the driver and passengers.

### BACKGROUND OF THE INVENTION

1. Field of the Invention

The present invention relates generally to electronic safety devices, and more particularly to an electronic safety device for a motor vehicle that is involved in a road accident.

2. Prior Art

The increasing use of motor vehicles in many parts of the world is inevitably accompanied by an increase in the number of road accidents. A so-called air bag is now a standard feature of many production cars. Usually, an air bag for a driver is located at the steering wheel of the car. The air bag instantaneously inflates when vehicle impact occurs, thereby helping prevent the driver from sustaining injury. In addition, a Global Positioning System (GPS) is also installed in some motor vehicles, and can be used by the driver in an emergency to advise the police of the vehicle's location. However, if the driver involved in a road accident is disabled, he/she may be incapable of trying to obtain assistance. Furthermore, the driver may simply be too shocked to be able to call the police or others for help.

Therefore, an electronic safety device for motor vehicles which can overcome the above-described problems is desired.

### SUMMARY OF THE INVENTION

Accordingly, an object of the present invention is to provide an electronic safety device for a motor vehicle which can automatically and effectively summon help for a person involved in a road accident.

To achieve the above-mentioned object, an exemplary electronic safety device for a motor vehicle includes a mobile phone, a GPS module, an air bag assembly, and a trigger. The mobile phone includes a camera module adapted to take images from inside the motor vehicle, and a predetermined phone number stored therein. The GPS module is for providing information on a position of the motor vehicle. The air bag assembly includes an extensile air bag. The mobile phone, the GPS module, the air bag assembly, and the trigger are electrically connected together. In the event of a road accident, the trigger is activated. The trigger enables the camera module to take an image, the GPS module to obtain information on the position of the motor vehicle and send the position information to the mobile phone, and the extensile air bag to be instantaneously charged. The mobile phone then sends the image and the position information to a receiver according to the predetermined phone number. Thus timely and informed help is automatically summoned for the driver and passengers.

Other objects, advantages and novel features of the invention will become more apparent from the following detailed description when taken in conjunction with the accompanying drawings, in which:

### BRIEF DESCRIPTION OF THE DRAWINGS

FIG. 1 is a plan view of an electronic safety device in accordance with a preferred embodiment of the present invention; and

FIG. 2 is a schematic diagram of electrical relationships between main elements of the electronic device in accordance with the preferred embodiment of the present invention.

### DETAILED DESCRIPTION OF THE INVENTION

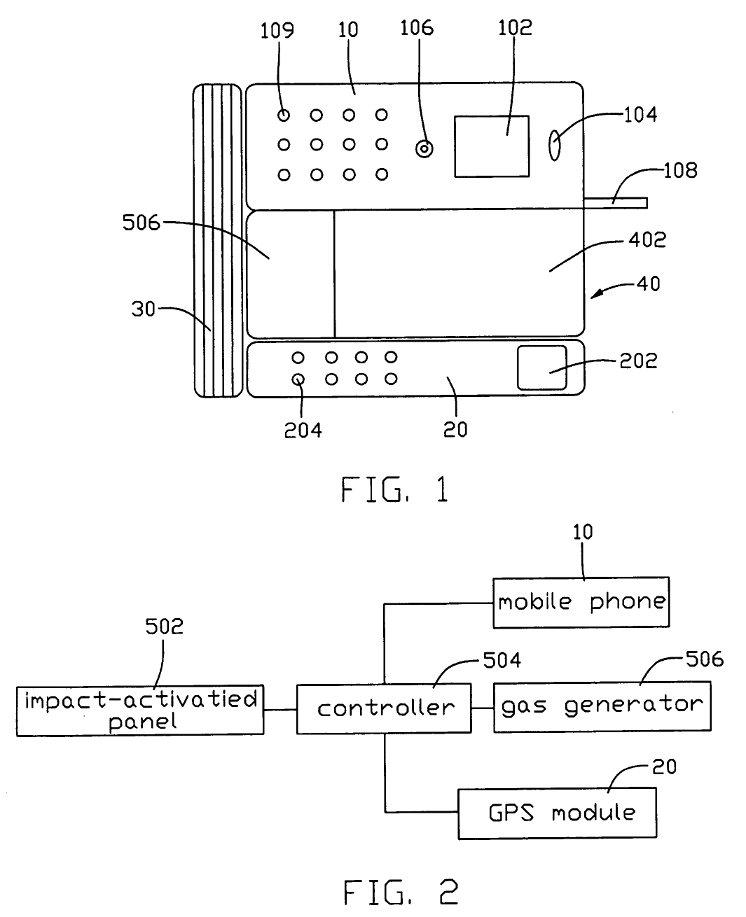

Referring to FIG. 1, an electronic safety device for a motor vehicle in accordance with the preferred embodiment of the present invention includes a mobile phone 10 as a remote communicating device in the motor vehicle, a GPS module 20, a trigger 30 and an air bag assembly 40 as a physical protection assembly of the motor vehicle. The electronic safety device is set near a steering wheel of the motor vehicle. Each of the mobile phone 10, GPS module 20, trigger 30 and air bag assembly 40 has at least one connector, through which these four elements can be electrically connected together.

The mobile phone 10 includes a display 102, a microphone 104, a camera module 106, an antenna 108, and several keys 109. The camera module 106 is set between the display 102 and the keys 109. The microphone 104 is set at an opposite side of the display 102 from the camera module 106. The GPS module 20 includes a display 202 and several keys 204. The display 202 is used to show general position information. Referring also to FIG. 2, the trigger 30 includes an impact-activated panel 502 set on a side thereof, and a controller 504 therein. The impact-activated panel 502 has preferably a sound activated sensor, piezo-electric sensor, force transducer, Micro Electro-Mechanical Systems (MEMS) sensor or acoustic sensor. The air bag assembly 40 includes a gas generator 506 and an extensile air bag 402. The gas generator 506 includes solid fuel and an ignitor therein. When the gas generator 506 is enabled, the ignitor ignites the solid fuel to instantaneously produce gases such as gases of nitrogen or gases of carbonic oxide. The gases instantaneously charge the extensile air bag 402.

FIG. 2 shows electrical connections between the main elements of the electronic safety device. The impact-activated panel 502 is connected with the controller 504, and the controller 504 is connected with the mobile phone 10, the GPS module 20 and the gas generator 506 in series.

When a road accident happens, the impact-activated panel 502 is pressed and activates the controller 504. The controller 504 sends control signals to the mobile phone 10, the GPS module 20, and the gas generator 506 at the same time. As soon as it receives the control signal, the gas generator 506 generates gas that instantaneously charges the extensile air bag 402. The duly inflated extensile air bag 402 thus dampens any impact injury that the driver might sustain. At the same time, the GPS module 20 sends information on a current position of the motor vehicle to the mobile phone 10. The camera module 106 is enabled to obtain an image of the interior of the motor vehicle, and the mobile phone 10 sends the position information and the image to a predetermined receiver. The predetermined receiver can, for example, be a police emergency office or another kind of emergency service. The corresponding phone number is pre-stored in the mobile phone 10. Thus timely and informed help is automatically summoned for the driver and passengers.

In addition, the mobile phone 10 preferably includes a microphone (not shown) and a voice recognition device (not shown) therein. The voice recognition device is connected with the controller 504. In an emergency, a predetermined voice command can be received by the microphone and recognized by the voice recognition device, which then enables the controller 504. The controller 504 then enables the camera module 106, the GPS module 20, and the gas generator 506.

It is to be understood that the mobile phone 10 can be configured so that it is detachable from the electronic safety device and usable as an independent general-purpose mobile phone. Further, the mobile phone 10, the GPS module 20, the trigger 30 and the air bag 40 can be integrated in a single housing, or can be formed as a single integrated body.

It is believed that the present invention and its advantages will be understood from the foregoing description, and it will be apparent that various changes may be made thereto without departing from the spirit and scope of the invention or sacrificing all of its material advantages. The examples hereinbefore described are merely preferred or exemplary embodiments of the invention.

1. An electronic safety device for a motor vehicle, comprising:
a mobile phone comprising at least one predetermined contact number stored therein, and a camera module adapted to take images from inside the motor vehicle;
a Global Positioning System (GPS) module for providing information on a position of the motor vehicle;
an air bag assembly comprising an extensile air bag; and
a trigger electrically connected with said mobile phone, said GPS module, and said air bag assembly;
whereby when said trigger is activated, it enables said camera module to take an image, said GPS module to obtain information on the position of the motor vehicle and send the position information to said mobile phone, and said extensile air bag to be charged, and said mobile phone is further enabled to send the image and the position information to at least one receiver according to said predetermined contact number.

2. The electronic safety device as claimed in claim 1, wherein said air bag assembly further comprises a gas generator.

3. The electronic safety device as claimed in claim 2, wherein said gas generator comprises an ignitor and a solid fuel, and when said gas generator is enabled, said ignitor ignites said solid fuel to produce gases that instantaneously charge said extensile air bag.

4. The electronic safety device as claimed in claim 1, wherein said trigger comprises a controller therein, and said controller is electrically connected with said mobile phone, said GPS module, and said air bag assembly.

5. The electronic safety device as claimed in claim 4, wherein said trigger further comprises an impact-activated panel on a side thereof, and said impact-activated panel is electrically connected with said controller.

6. The electronic safety device as claimed in claim 4, wherein said mobile phone further comprises a microphone and a voice recognition device, whereby a predetermined voice command can be received by the microphone and recognized by the voice recognition device, which can then enable said controller.

7. A method for automatically summoning help regarding a motor vehicle involved in a road accident, comprising the steps of:
activating a trigger;
enabling a camera module of a mobile phone to take at least one image from an inside of the motor vehicle, enabling an air bag assembly, and enabling a Global Positioning System (GPS) module to obtain information on a position of the motor vehicle and send the position information to said mobile phone; and
enabling said mobile phone to send the image and the position information to a predetermined receiver.

8. The method as claimed in claim 7, wherein said trigger comprises a controller, and said controller is electrically connected with said mobile phone, said air bag assembly, and said GPS module.

9. The method as claimed in claim 8, wherein said trigger further comprises an impact-activated panel electrically connected with said controller, and step a. further comprises the steps of:
activating said impact-activated panel; and
enabling said controller.

10. The method as claimed in claim 8, wherein said mobile phone comprises a microphone and a voice recognition device, and step a. further comprises the steps of:
activating said voice recognition device; and
enabling said controller.

11. The method as claimed in claim 7, wherein said mobile phone comprises a predetermined contact number of the predetermined receiver.

12. An electronic safety device for a motor vehicle, comprising:
an impact-sensing trigger disposed in said motor vehicle for identifying a crash of said motor vehicle;
a physical protection assembly installed in said motor vehicle and used to provide physical protection to a driver of said motor vehicle, said physical protection assembly electrically connected to said impact-sensing trigger so as to perform said physical protection based on signals from said impact-sensing trigger; and
a remote communicating device disposed in said motor vehicle and reachable by said driver, and electrically connected to said impact-sensing trigger so as to perform remote communication with a predetermined receiver based on said signals from said impact-sensing trigger.

13. The electronic safety device as claimed in claim 12, wherein said remote communicating device comprises a camera module adapted to take pictures of said motor vehicle based on said signals from said impact-sensing trigger.

14. The electronic safety device as claimed in claim 12, wherein said impact-sensing trigger comprises one of the group consisting of a sound activated sensor, a piezo-electric sensor, a force transducer, a Micro Electro-Mechanical Systems (MEMS) sensor and an acoustic sensor.

15. The electronic safety device as claimed in claim 12, further comprising a Global Positioning System (GPS) module electrically connected to said impact-sensing trigger for providing information on a position of said motor vehicle based on said signals from said impact-sensing trigger.
